(19) United States
(12) Patent Application Publication
(10) Pub. No.: US 2006/0279624 A1
(43) Pub. Date: Dec. 14, 2006

(54) Printer, printing control method for a printer and computer program for a printer

(76) Inventors: Akihiko Tsuchiya, Tomi-shi (JP); Tomoaki Kimura, Shiojri-shi (JP)

Correspondence Address: ANDERSON KILL & OLICK P.C., 1251 Avenue of the Americas, New York, NY, 10020, US

(21) Appl. No.: 11/450,645

(22) Filed: Jun. 9, 2006

(30) Foreign Application Priority Data
Jun. 10, 2005 (JP) 2005-170465

(51) Int. Cl. B41J 2/325; B41J 11/00; G01D 15/24

(52) U.S. Cl. 347/218

(57) ABSTRACT

A printer for printing to label paper and other types of continuous paper minimizes wasteful consumption of continuous paper and enables operating in a self-printing mode conforming to the specifications of the continuous paper currently in use. The printer prints to roll paper including label paper having a plurality of labels affixed to a continuous web backer with a gap between the labels. A paper transportation control unit controls the transportation mechanism for conveying the roll paper along a transportation path. A printing control unit controls a printing mechanism including a print head disposed to the transportation path. A sensor disposed on the upstream side in the transportation direction from the print head detects paper information about the roll paper. A print data generating unit generates the self-printing data based on information stored in the printer. The paper transportation control unit has a printing start position control unit that determines the printing start position of the self-printing data and positions the continuous paper to the print head based on the paper information, and a next-line printing position control unit that determines the printing start position of the self-printing data to be printed next and positions the continuous paper to the print head based on the paper information after printing the self-printing data starts.

### BACKGROUND OF THE INVENTION

1. Field of Technology

The present invention relates to a printer for printing to continuous label paper, a printing control method for a printer for printing to continuous label paper, and to a computer program for executing the printing control method.

2. Description of Related Art

Printers that print to roll paper or other type of continuous print medium that is stored inside the printer are common today. Examples of such printers include POS printers, ticket printers for printing queuing tickets, for example, and portable handheld printers.

FIG. 11 shows oblique views of roll paper such as used in this type of printer. The plain paper P1 shown in FIG. 11A is a continuous length of plain, unmarked paper wound into a roll. The marked plain paper P2 shown in FIG. 11B has index marks 20 of a predetermined length L3 printed at a predetermined interval L4 along one edge on the back side (the normally unprinted side) of plain paper P1. The die-cut label paper P3 shown in FIG. 11C has labels 19 of a predetermined length L1 adhesively affixed at a predetermined interval L2 on a continuous web 18 which is then wound into a roll. Marked die-cut label paper P4 such as shown in FIG. 11D has index marks 20 of a predetermined length L5 printed between each label at a predetermined interval L6 along one edge on the back side (the label-free side) of die-cut label paper P3. While not shown in the figures, other types of continuous paper render these index marks 20 as detectable holes or notches in the paper instead of preprinted marks.

These printers also commonly have a printer status print function for printing information relating to the current printer settings or operating status. Printers with a test print function for verifying the print quality, a demonstration print function used as a sales tool for in-store printer demonstrations, and a dump print function for printing based on content dumped from the printer's memory, are also known. Functions whereby the printer prints information contained within the printer instead of print data sent from a host device are referred to herein as “self-printing functions.” The printer can operate in the self-printing mode as an independent stand-alone device.

Print data printed in the self-printing mode is uniformly generated by the printer firmware irrespective of the type of continuous paper stored in the printer. If the continuous paper is plain paper P1, there are no unprintable areas in the transportation direction of the paper and all print data (printed lines 92a to 92g in FIG. 12A) are printed based on the print data generated by the printer as shown in FIG. 12A. If the continuous paper is die-cut label paper P3, however, the web 18 or waste matrix creates an unprintable area between the labels 19, which define the printing areas in the transportation direction of the paper. If printing proceeds without considering the position of the waste matrix or web 18 between the labels, part of the print data (line 92d in this example) will not be printed correctly as shown in FIG. 12B. Printing problems thus occur in the self-printing mode when there are non-printing areas in the transportation direction of the continuous paper stored in the printer.

This makes it necessary either for the operator to manually set the type of continuous paper in the printer, or for the printer to automatically detect the type of continuous paper being used, before printing in the self-printing mode. The printer taught in JP-A-2002-205872, for example, has an optical sensor that emits light to the continuous paper and determines the type of continuous paper being used based on the levels of light reflected by and passing through the paper.

JP-A-64-9769 teaches a perforation-skipping device that has a detector for detecting the perforations in perforated fan-fold (continuous) paper and automatically leaving a desired margin, that is, a non-printing area, before and after each perforation. To automatically leave a desired non-printing margin before and after each perforation, this perforation-skipping device sets the stop-printing line number counted from the detected perforation position in a first counter, sets the start-printing line number counted from the detected perforation position in a second counter, and starts first and second counter operation when the detector detects a perforation. The first counter then outputs a signal to stop printing when the count of the first counter becomes equal to the end-printing line number, and the second counter outputs a signal to start printing when the count of the second counter becomes equal to the start-printing line number.

JP-A-2002-166634 teaches a printer that determines the label size and test prints based on the label size. This printer uses an optical sensor to detect index marks provided on the back side of the label paper web to denote the label position, determine the label size from the detected marks, select a test print pattern corresponding to the label size from among a plurality of test print patterns stored in memory, and thus automatically print a test pattern according to the label size of the currently loaded label paper.

If the printer requires the operator to manually set the type of continuous paper in the printer printing problems will result if the paper type is not set or if the operator sets the wrong paper type. In addition, some printers of this type will not print if the type of continuous paper that is actually loaded in the printer does not match the continuous paper type setting of the printer.

A problem with prior art enabling the printer to automatically detect the type of continuous paper results from the need in such prior art to convey the roll paper in order to determine the type of continuous paper that is loaded in the printer which wastes paper. For example, if label paper is used, this typically wastes two or three labels. If a portable handheld printer is used, the diameter of the paper roll that can be loaded into the printer is small. If roll paper is being wasted, the roll paper must be replaced more frequently. This increases the workload for the operator and lowers the efficiency of the printing tasks.

In addition to requiring the operator to set the stop-printing line number and start-printing line number according to the type of fanfold paper (or more precisely, according to the distance between perforations), another problem with the prior art perforation-skipping device described above is that printing cannot start until after a perforation is detected, and paper is thus wasted.

A problem with the prior art method of selecting and printing a test pattern according to the label size is that a test print pattern must first be stored in the printer for each usable label size. This requires a corresponding amount of memory, an inability to use all types of continuous paper, and thus a loss of general utility.

### SUMMARY OF THE INVENTION

The present invention is directed to solving the problems in prior art printers as indicated above and to provide a printer that can operate in a self-printing mode according to the specifications of the continuous paper while minimizing continuous paper waste.

The printer of the present invention for printing on continuous paper including label paper having a plurality of labels disposed with a gap therebetween on a continuous web liner comprises a paper transportation control unit for controlling the transportation of the continuous paper along a transportation path using a transportation mechanism; a printing control unit for controlling printing on the continuous paper using a printing mechanism including a print head disposed along the transportation path; detector located on the upstream side of the print head in the transportation direction for detecting paper information from the continuous paper; and a print data generating unit for generating self-printing data based on information that is stored in the printer; wherein the paper transportation control unit comprises a printing start position control unit for determining a printing start position for a first line of the self-printing data and positioning the continuous paper at the printing start position relative to the print head based on the paper information, and a next-line printing position control unit for determining a printing start position for each consecutive line of the self-printing data to be printed next and positioning the continuous paper at each consecutive printing start position relative to the print head based on the paper information.

Preferably, the detector detects if an unprintable area is present on the continuous paper; and if an unprintable area is detected at the detector before transportation of the continuous paper starts the printing start position control unit positions the continuous paper to start printing from a printable area of the continuous paper adjacent the upstream side of the unprintable area.

Further preferably, the printing start position control unit controls the transportation of the continuous paper when an unprintable area is not at the detector before transportation of the continuous paper starts, and when an unprintable area is detected after continuous paper transportation starts but before the continuous paper travels the distance along the transportation path between the detector and the print head the printing start position control unit positions the continuous paper to start printing from the printable area adjacent the upstream side of the unprintable area.

Alternatively, the printing start position control unit controls the transportation of the continuous paper when an unprintable area is not at the detector before transportation of the continuous paper starts, and when an unprintable area is detected after continuous paper transportation starts but before the continuous paper travels the distance along the transportation path between the detector and the print head the printing start position control unit positions the continuous paper to start printing from the printable area that is positioned at the print head.

Further preferably, the detector detects a printable area and an unprintable area on the continuous paper; and the next-line printing position control unit comprises a printable area information acquisition unit for acquiring unprinted area information for printing in an unprinted area of the printable area positioned at the print head, and a printing process control unit for determining if the self-printing data to be printed next can be printed in the unprinted area, and when the printing process control unit determines that the self-printing data to be printed next cannot be printed in the unprinted area the next-line printing position control unit positions the continuous paper to start printing from the printable area adjacent on the upstream side of the unprintable area.

Yet further preferably, the next-line printing position control unit positions the continuous paper every line or every pass (corresponding to a predetermined number of lines).

The present invention can also be expressed as a printer control method affording the same operation and effect.

The printer control method of the invention can also be part of a computer program that can be executed by the printer control unit or stored in a data recording medium for executing the printing control method in the printer.

A printer according to the present invention operates in a self-printing mode even if the type of continuous paper is not defined in the printer and prints while detecting the unprintable areas of the continuous paper to determine if print data can be printed in the unprinted part of the printable area of the continuous paper. Wasteful discharge of continuous paper can also be minimized because the printing start position for starting printing in the self-printing mode can be set appropriately based on whether there is an unprintable area on the continuous paper.

Other advantages and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view showing a printer when the cover is closed.

FIG. 2 is an oblique view showing a printer when the cover is open.

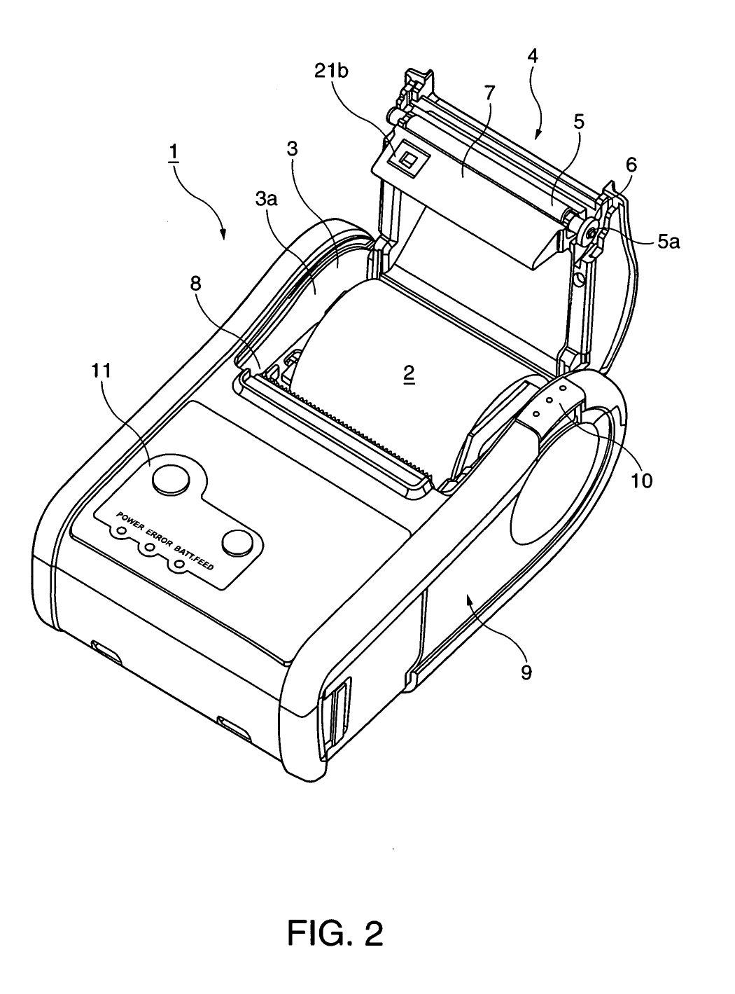

FIG. 3 is a section view of a sensor.

FIG. 4 shows the reflected and transmitted light levels detected with different types of continuous paper.

FIG. 5 is a control block diagram for a printer.

FIG. 6 is a function block diagram of the paper transportation control unit.

FIG. 7 is a flow chart showing the procedure for determining the printing start position in the self-printing mode.

FIG. 8 is a flow chart of the printing procedure in the self-printing mode.

FIG. 9 describes transportation of the continuous paper in the procedure for determining the printing start position in the self-printing mode.

FIG. 10 describes transportation of the continuous paper during the printing process in the self-printing mode.

FIG. 11A to FIG. 11D are oblique views describing different types of continuous paper.

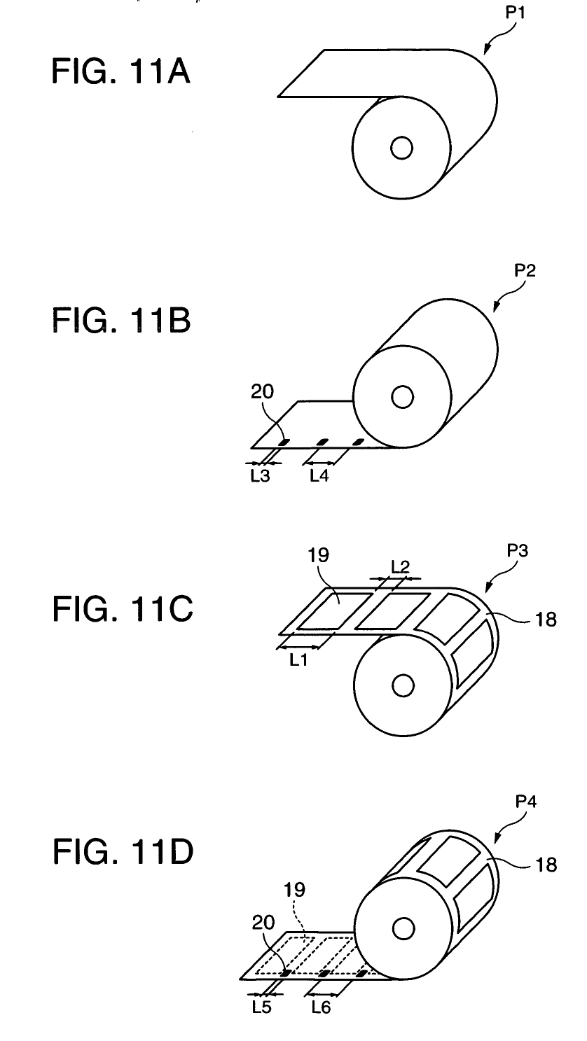

FIG. 12 describes the printer output in a prior art self-printing mode with FIG. 12A showing the result when printing to plain paper, and FIG. 12B showing the result when printing to label paper.

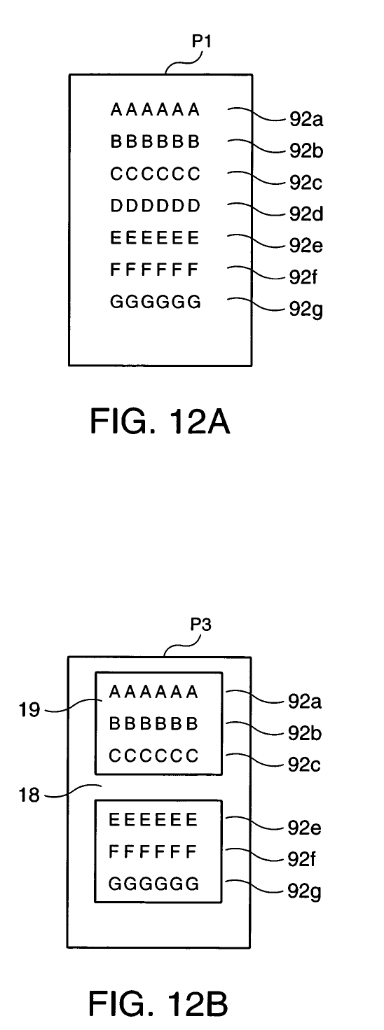

### DESCRIPTION OF THE PREFERRED EMBODIMENTS

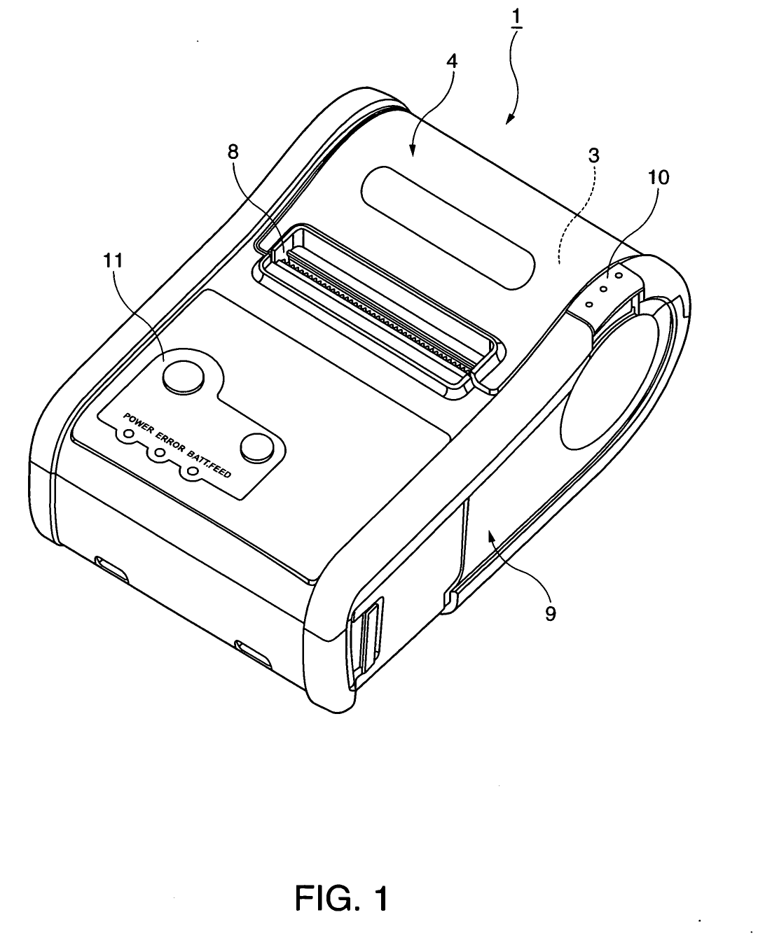

A printer 1 according to one embodiment of the invention and as is shown in FIG. 1 includes a case 9 and a storage unit 3 for holding roll paper 2 inside the printer 1. The roll paper 2 is loaded and replaced through opening 3a to the storage unit 3. The opening 3a to the storage unit 3 is opened and closed by a cover 4 that pivots freely up and down on a pivot point at the back of the case 9. The cover 4 is opened by pressing down on a cover opening button 10.

A discharge slot 8 is formed between the distal edge of the cover 4 and the front edge of the opening 3a, and the free end of the roll paper 2 inside the storage unit 3 passes through the transportation path and is discharged from this discharge slot 8. Transportation roller 5 is disposed widthwise to the printer 1 at the distal end part of the cover 4, and a driven gear 6 is fixed at the right end part of the transportation roller shaft 5a. A guide plate 7 for guiding the roll paper 2 is also attached at the distal end part of the cover 4.

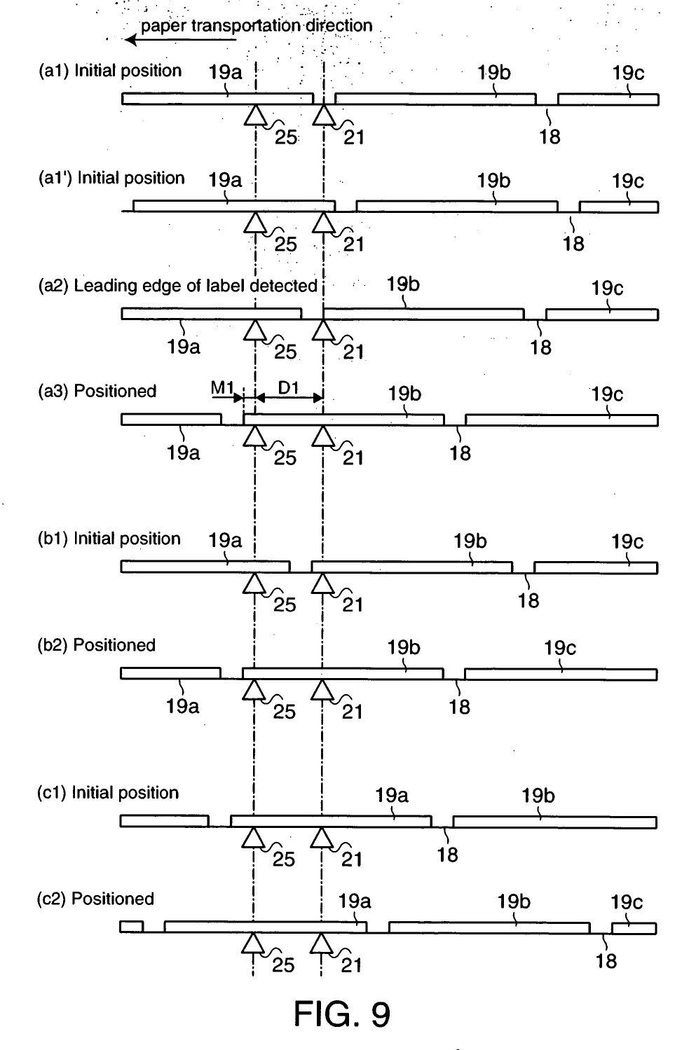

A thermal print head 25 (see FIG. 9) is located on the case 9 side of the printer 1 at a position opposite the transportation roller 5 when the cover 4 is closed. The print head 25 is pressed against the transportation roller 5 (platen) by a spring or other urging means. Also disposed inside the case 9 are a transportation motor and a drive gear (train) that meshes with the pinion affixed to the rotating shaft of the transportation motor. The driven gear 6 meshes with the drive gear (train) when the cover 4 closes, thus enabling the transportation motor to drive the transportation roller 5 rotationally and completing the transportation path whereby the transportation roller 5 conveys the printing paper passed the printing position of the print head 25.

Printing paper delivered from the roll paper 2 held in the storage unit 3 is thus printed by the print head 25 and then discharged from the discharge slot 8 as the paper travels upward between the print head 25 and transportation roller 5.

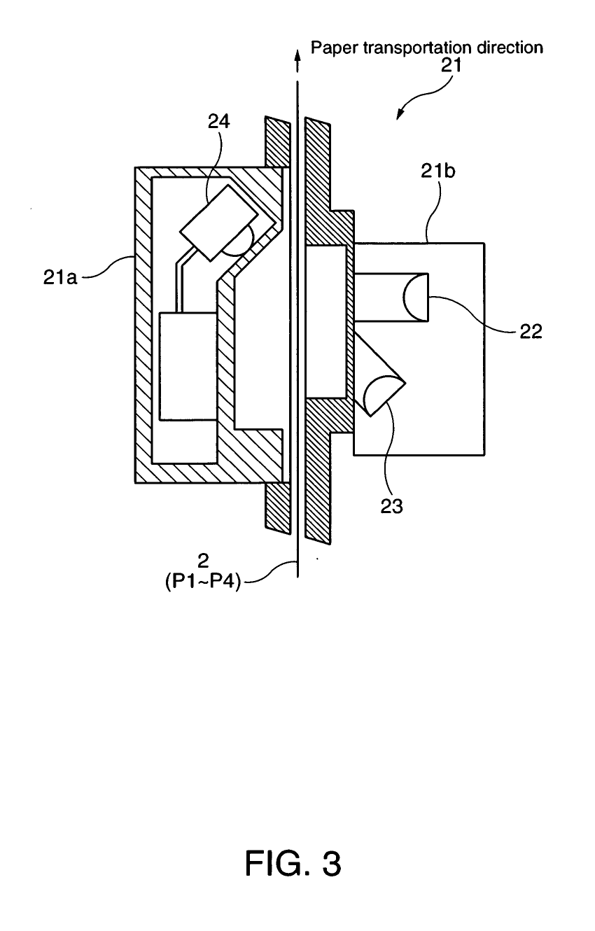

A transmitted/reflected light sensor 21 (simply “sensor” below) for detecting paper information such as the type and position of the roll paper 2 is disposed to the transportation path near the upstream side of the print head 25. As shown in FIG. 3, this sensor 21 has sensor units 21a and 21b on opposite sides of the transportation path. The back sensor unit 21b facing the back side (unprinted side) of the roll paper 2 is disposed to the guide plate 7 on the cover 4 side of the transportation path, and in combination with a light-emitting element 22 for reflectance detection and photodetector 23 renders a reflection type optical sensor. The front sensor unit 21a facing the front (printed) side of the roll paper 2 is disposed on the case 9 side of the transportation path, and has a light-emitting element 24 for optical transmittance detection. The light-emitting element 24 for optical transmittance detection is disposed opposite the photodetector 23, and light-emitting element 24 and photodetector 23 together constitute a transmittance type optical sensor. The light-emitting element 22 for reflectance detection and the light-emitting element 24 for transmittance detection are driven to alternately emit signals synchronized to the paper feed pitch (1 dot), and the photodetector 23 alternatively generates a synchronized output of a reflectance level signal and a transmittance level signal.

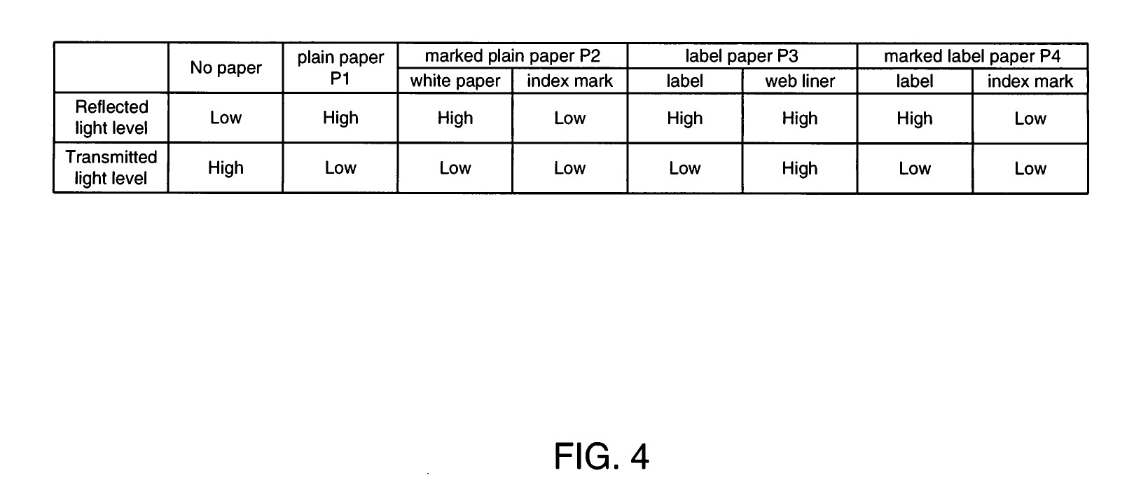

FIG. 4 describes the reflectance and transmittance level signals detected from different types of continuous paper. As shown in FIG. 4, when the sensor 21 is not covered by continuous paper, that is, the continuous paper is not located between the emitter and the detector of the sensor 21, the reflectance level is Low and the transmittance level is High.

When plain paper P1 is used, the reflectance level is High and the transmittance level is Low regardless of which part of the paper is at the sensor 21.

When marked plain paper P2 is used, the reflectance/transmittance levels are High/Low where the paper is white (i.e., the index mark is not in front of the sensor) and Low/Low when an index mark is detected.

When die-cut label paper P3 is used, the reflectance/transmittance light levels are High/Low at a label and High/High at the web between labels.

When marked die-cut label paper P4 is used, the reflectance/transmittance light levels are High/Low at a label and Low/Low when an index mark is detected.

The printer 1 detects the reflectance level and transmittance level by means of the sensor 21 while conveying the roll paper 2, and determines the type of roll paper 2 based on the reflectance level. For example, if the reflectance/transmittance levels are High/Low, respectively, and the reflectance/transmittance levels do not change even though the paper has been conveyed a predetermined distance, plain paper P1 is known to be in use. Likewise, if the reflectance/transmittance levels change from High/Low to High/High before the paper has travelled a predetermined distance, die-cut label paper P3 is known to be in use.

As will be known from FIG. 4, marked plain paper P2 and marked die-cut label paper P4 cannot be differentiated in this embodiment of the invention because the reflectance/transmittance levels are the same. In this situation the printer 1 in this embodiment of the invention therefore decides that marked die-cut label paper P4 is being used. While there are no unprintable areas on marked plain paper P2, marked die-cut label paper P4 has areas that cannot be printed and printing problems can thus be prevented by handling the paper as marked die-cut label paper P4 in this situation.

It will also be obvious that the white portion of plain paper and the label portion of label paper, and therefore marked plain paper P2 and marked die-cut label paper P4, can be distinguished from each other depending upon the sensor that is used and the threshold values used for determining the paper type. This is because the reflectance/transmittance levels are High/High in the white portion of plain paper and are High/Low in the label portion of label paper.

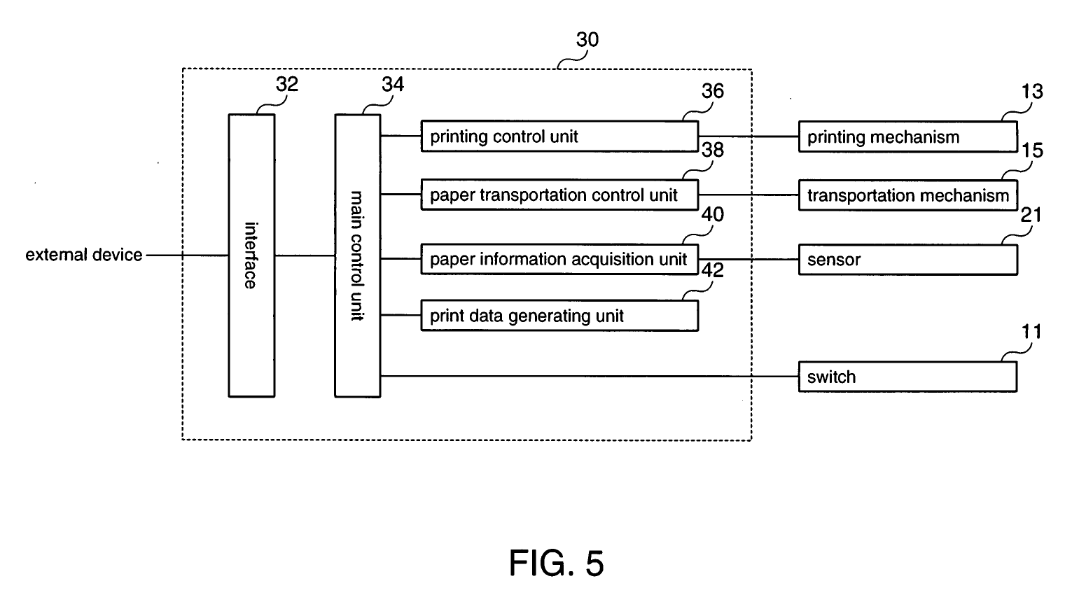

FIG. 5 is a control block diagram of the printer 1 in this embodiment of the invention. This printer 1 has a printing mechanism 13 including the print head 25, a transportation mechanism 15 including the transportation roller 5, driven and drive gears, and the transportation motor, the sensor 21, switches 11 for inputting power on/off commands, paper feed commands, and self-printing mode commands, and a control unit 30 for controlling these other parts. The control unit 30 is further described below.

The control unit 30 comprises a interface 32, main control unit 34, printing control unit 36, paper transportation control unit 38, paper information acquisition unit 40, and print data generating unit 42.

The print data generating unit 42 generates the self-printing data in reply to a self-printing mode command applied by the switch 11 or from an external device connected to the printer 1. The print data generating unit 42 collects information about the positions of the DIP switches disposed to the printer 1, the communication parameters of the interface 32, and the firmware version, for example, and formats this data in a predetermined way to generate the print data.

The paper information acquisition unit 40 acquires the paper information based on the detection signals from the sensor 21. More particularly, the paper information acquisition unit 40 determines the type of roll paper 2, determines if labels 19 or index marks 20 are on the roll paper 2, and determines the label or index mark position if they are detected.

The paper transportation control unit 38 controls the transportation mechanism 15 to convey the roll paper 2 based on the control commands and print data from an external device and switch 11 operation. When operating in the self-printing mode, the paper transportation control unit 38 controls the transportation mechanism 15 and conveys the roll paper 2 based on the paper information for the roll paper 2 acquired by the paper information acquisition unit 40 and the self-printing data generated by the print data generating unit 42.

The printing control unit 36 controls the printing mechanism 13 based on print data from an external device and self-printing data from the print data generating unit 42 to drive the print head 25 and thereby print on the roll paper 2.

The main control unit 34 controls overall operation of the printer 1. More particularly, the main control unit 34 receives control commands, print data, and other data from a host device through the interface 32, and controls the parts of the control unit 30 to execute a process corresponding to the received data. During printing processes, the main control unit 34 synchronizes operation of the printing mechanism 13 controlled by the printing control unit 36 to the control of roll paper 2 transportation by the paper transportation control unit 38 to print desirably on the roll paper 2.

The control unit 30 in this embodiment of the invention comprises a CPU, ROM storing firmware (control program), and RAM that functions as a send/receive buffer, print buffer, and working memory.

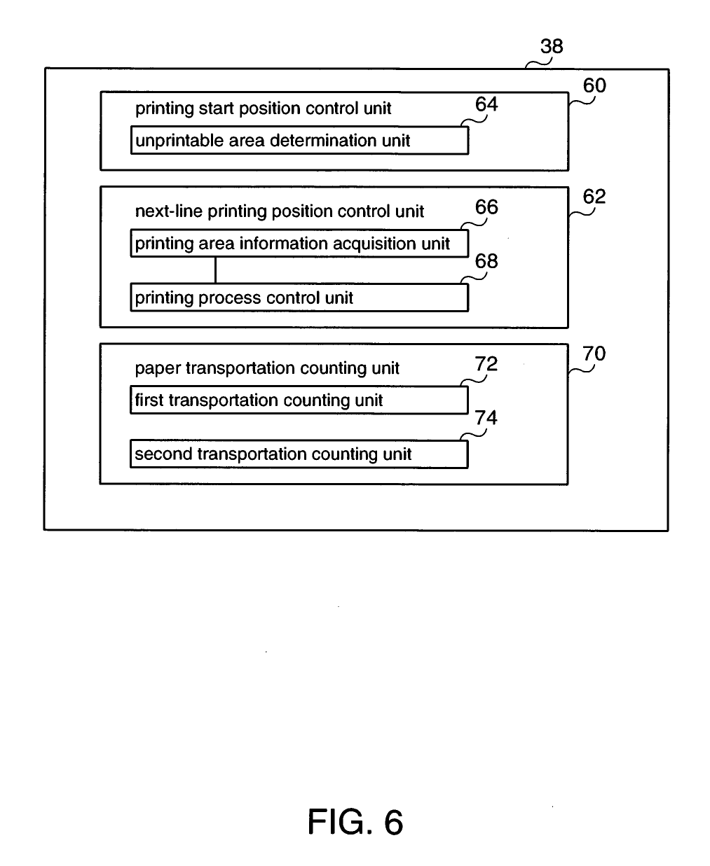

FIG. 6 is a function block diagram of the paper transportation control unit 38. The paper transportation control unit 38 comprises a printing start position control unit 60, next-line printing position control unit 62, and paper transportation counting unit 70.

The printing start position control unit 60 determines the position of the first line when starting the self-printing mode, and positions the roll paper 2 to this printing position.

After printing in the self-printing mode starts, the next-line printing position control unit 62 determines where to start printing the next line for the second and each subsequent line, and positions the roll paper 2 to the printing position.

The paper transportation counting unit 70 comprises a first transportation counting unit 72 and a second transportation counting unit 74. The first transportation counting unit 72 measures the transportation distance of the roll paper 2 from when the trailing end (the upstream end in the transportation direction) of the label 19 or the leading end (the downstream end in the transportation direction) of an index mark 20 is detected. The second transportation counting unit 74 measures the transportation distance of the roll paper 2 from when the leading end (the downstream end in the transportation direction) of a label 19 or the trailing end (the upstream end in the transportation direction) of an index mark 20 is detected. The counts returned by the paper transportation counting unit 70 are used for roll paper 2 transportation control by the printing start position control unit 60 and next-line printing position control unit 62.

The printing start position control unit 60 has an unprintable area determination unit 64 that determines if there is an unprintable area on the roll paper 2 based on the paper information acquired for the roll paper 2 by the paper information acquisition unit 40. When the self-printing mode starts, if an unprintable area on the roll paper 2 is determined to exist while conveying the roll paper 2 a distance D1 (the “sensor-head distance D1” below), corresponding to the distance between the sensor 21 and print head 25, along the transportation path, the roll paper 2 is further advanced to position the next printable area to the print head 25 and that paper position is used as the printing start position. If an unprintable area is not present, the position of the paper is used as the printing start position.

For example, if the roll paper 2 is label paper (P3 or P4), the web 18 itself is an unprintable area. As a result, if the sensor 21 detects the web 18 while the roll paper 2 is being advanced the sensor-head distance D1, the roll paper 2 will be further advanced in order to print on the label 19 following the detected web 18.

In the above example the roll paper 2 is advanced the sensor-head distance D1 because the sensor 21 cannot detect an unprintable area located between the sensor 21 and print head 25 when transportation has first started, and starting printing in this situation will result in a printing defect.

The next-line printing position control unit 62 comprises a printing area information acquisition unit 66 and printing process control unit 68. The printing area information acquisition unit 66 acquires information about printable areas on the roll paper 2 and the extent of the unprinted area E remaining in the printable area based on the paper information acquired by the paper information acquisition unit 40 for the roll paper 2. The printing process control unit 68 determines if the next line of print data can be printed in the remaining unprinted area E of the printable area on the roll paper 2 based on the unprintable area information acquired for the roll paper 2 by the printing area information acquisition unit 66 and the next line of print data to be printed from the self-printing data generated by the print data generating unit 42 (the “next-line print data” below).

If the printing process control unit 68 determines that the next line of print data can be printed, the next-line printing position control unit 62 sets that position as the printing start position for the next line. However, if the printing process control unit 68 determines that the next line cannot be printed, the roll paper 2 is advanced until the next printable area is positioned to the print head 25, and that position is used as the printing start position for the next line.

If the roll paper 2 is label paper (P3 or P4), for example, the printer determines if the next line of print data can be printed in the unprinted area E of the label 19 to be printed, and advances the roll paper 2 to print on the next label 19 if printing on the first label is not possible.

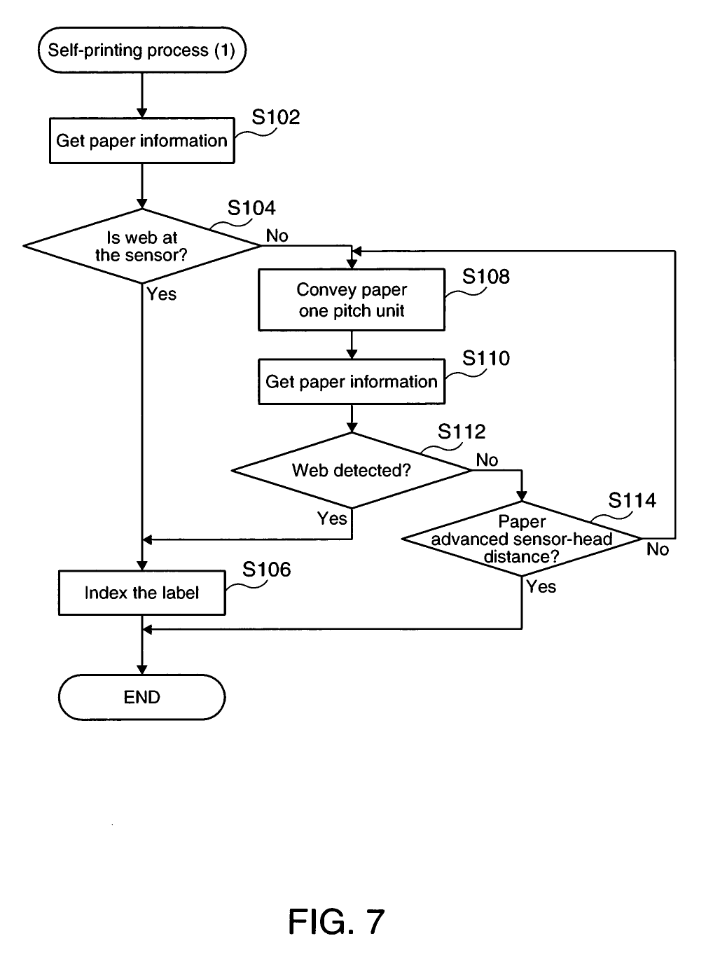

Operation in the self-printing mode is described next with reference to the flow charts in FIG. 7 to FIG. 10.

If a self-printing mode command is applied to the printer 1, the printer 1 advances the roll paper 2 to the printing start position and starts printing the first line of print data. The self-printing mode proceeds while determining if each next line of print data can be printed in the remaining unprinted area E of the printable area on the roll paper 2.

When a self-printing command is input, the paper information acquisition unit 40 gets the paper information for the roll paper 2 (S102) and determines if the web 18 is at the sensor 21 (S104). More specifically, the paper information acquisition unit 40 determines if the reflectance/transmittance levels output by the sensor 21 are High/High (indicating that die-cut label paper P3 is loaded) or Low/Low (indicating that marked label paper P4 is loaded). If the web 18 is at the sensor 21 (S104 returns Yes, corresponding to position (a1) in FIG. 9), the first label 19b on the upstream side of the web 18 is advanced to the printing position of the print head 25 (S106). More specifically, the leading edge part of the label is detected based on the output signals from the sensor 21 while advancing the roll paper 2 ((a2) in FIG. 9), and the roll paper 2 is then advanced a distance equal to the sensor-head distance D1 plus the desired top print margin M1 (M1>=0) from where the leading edge is detected. This sets the label 19b to the printing start position ((a3) in FIG. 9).

The leading edge of the label is detected by sensing when the reflectance/transmittance levels of the sensor 21 change from High/High or Low/Low to High/Low, and the second transportation counting unit 74 counts the transportation distance from when the leading edge of the label is thus detected. Note that when marked die-cut label paper P4 is detected the trailing edge of the index mark 20 is used as the leading edge of the label.

Furthermore, if the roll paper 2 loaded in the printer 1 is marked plain paper P2, this embodiment of the invention handles the roll paper 2 in the same way as marked die-cut label paper P4. More specifically, the index marks 20 on the marked plain paper P2 are processed as corresponding to the web 18 of the marked die-cut label paper P4.

If the web 18 is not at the sensor 21 (S104 returns No), the roll paper 2 is conveyed (S108) while acquiring the paper information (S110) to determine if the web 18 was detected (S112). If the web 18 is detected (S112 returns Yes) before the roll paper 2 is advanced the sensor-head distance D1 from the start of paper transportation, the first label 19b on the upstream side of the web 18 advances to the printing position of the print head 25 (S106). For example, if label paper (P3 or P4) is positioned as indicated in (a1′) in FIG. 9 before paper transportation starts, this operation positions the label paper as indicated by (a3) in FIG. 9.

If the web 18 is not detected by the time the roll paper 2 travels the sensor-head distance D1 from the start of paper transportation (S112 returns No and S114 returns Yes), the position of the paper when transportation stops is used as the printing start position. This situation is illustrated by lines (b1), (b2), (c1), and (c2) in FIG. 9. If the roll paper 2 loaded in the printer 1 is plain paper P1, the printing start position is at the sensor-head distance D1 from the start of paper transportation because plain paper P1 has no web 18.

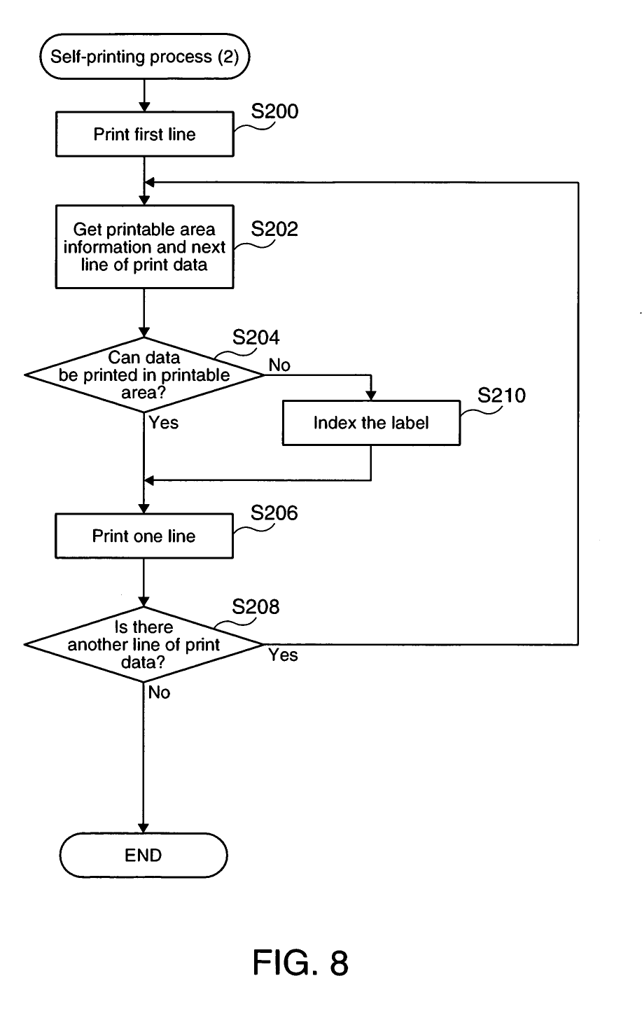

The process described with reference to the flow chart in FIG. 7 determines the printing start position in the self-printing mode, and then passes control to the printing process shown in FIG. 8 to start printing.

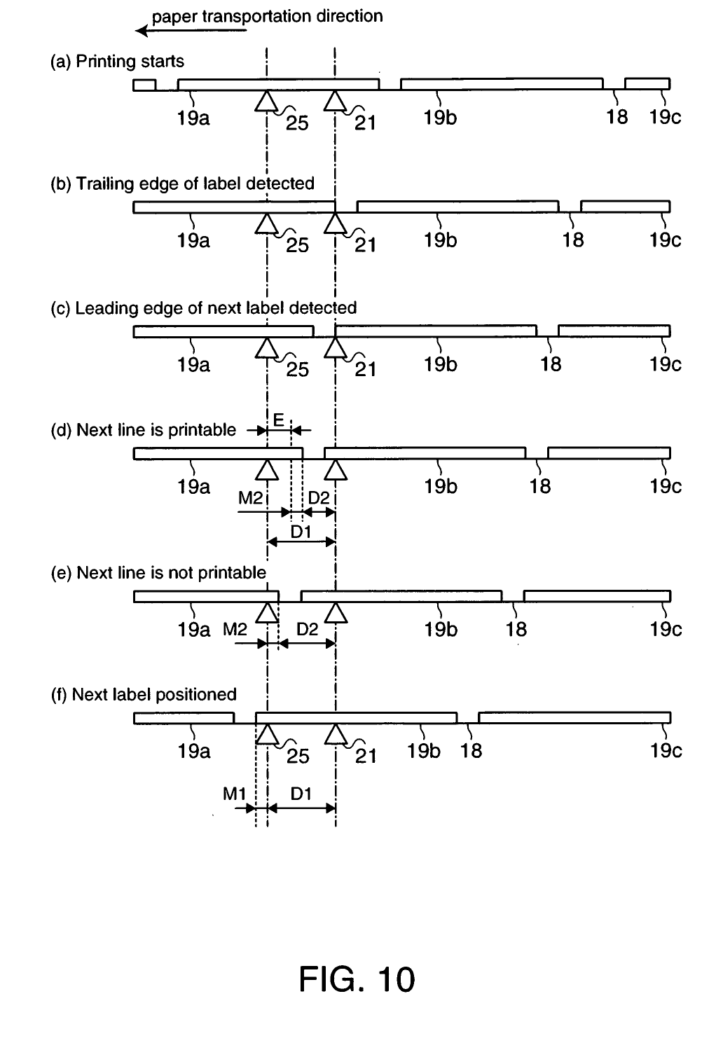

Once the roll paper 2 is positioned to the printing start position as indicated by line (a) in FIG. 10, the first line of print data is acquired and printed, and a line feed is executed (S200). The print data is generated by the print data generating unit 42, and can be acquired by reading the self-printing data stored in the print buffer.

The next line of print data and the information relating the unprinted area E of the roll paper 2 is then acquired (S202). The unprinted area E in the transportation direction of the roll paper 2 can be calculated by subtracting transportation distance D2 and the bottom print margin M2 (M2>=0) from the sensor-head distance D1 (that is, E=D1-D2-M2; see (b) and (d) in FIG. 10), where distance D2 is the distance from where the trailing edge of the label 19 (that is, the leading edge of the web 18 or the leading edge of the index mark 20) was detected by the sensor 21. The trailing edge of the label can be detected by sensing where the reflectance/transmittance levels output by the sensor 21 change from High/Low to High/High or Low/Low, and the first transportation counting unit 72 counts the transportation distance from where the trailing edge of the label is detected.

Whether the next line of print data can be printed in the unprinted area E is then determined (S204) by comparing the character height (or the line height) of the print data with the unprinted area E. If the height of the unprinted area E is greater than or equal to the character (line) height, the next line of print data can be printed.

If the roll paper 2 is plain paper P1, there is no web and the web cannot be detected, and there is no unprintable area on the paper. Printing can therefore continue until a No Paper state is detected, that is, until the paper runs out. If a No Paper state is detected, that is, if the trailing edge of the plain paper P1 is detected, information about the unprinted area E is acquired in the same way as when the trailing edge of a label 19 is detected, and whether or not the next line of print data can be printed is determined.

If the next line of print data can be printed in the unprinted area E (S204 returns Yes; (d) in FIG. 10), the line is printed (S206). However, if the next line of print data cannot be printed in the unprinted area E (S204 returns No; (e) in FIG. 10), the next adjacent label 19b on the upstream side of the label 19a currently positioned at the printing position is positioned to the printing position (S210; (f) in FIG. 10) and the next line of print data is then printed (S206). As in step S106 above, the positioning process in step S210 advances the paper a distance equal to the sensor-head distance D1 plus the top print margin M1 from the position where the leading edge of the label was detected (FIG. 10(c)).

If there is still print data to be printed (S208 returns Yes), the process from step S202 to S206 repeats for each line until no print data is left (S208 returns No), and the self-printing mode then ends.

A preferred embodiment of the present invention is described above with reference to the accompanying figures. The invention is not limited to this embodiment, however, and the invention includes all modifications and applications that will be apparent to one with ordinary skill in the related art based on the accompanying claims, the preferred embodiments described herein, and the literature.

For example, printing proceeds one line at a time in this preferred embodiment of the invention, but if the printer can print multiple lines in a single pass, determining whether printing is possible and printing in the printable area can be controlled pass by pass.

The trailing and leading edges of each index mark 20 are used to simplify identifying the leading and trailing edges of each label when processing marked die-cut label paper P4 in this embodiment of the invention, but the leading and trailing edges of each label can be detected in the same way as when processing die-cut label paper P3.

Furthermore, this embodiment of the invention starts printing from the next label 19 if when determining the printing start position in the self-printing mode the web 18 is not at the sensor 21 before transportation starts and the web 18 is detected before the paper advances the sensor-head distance D1. However, if the sensor-head distance D1 is less than or equal to (the length of the label 19 in the transportation direction minus top margin M1), and the sensor-head distance D1 is greater than or equal to (the self-printing character height plus bottom margin M2), the position where the web 18 (the trailing edge of the label 19) is detected can be set as the printing start position.

This embodiment of the invention calculates the unprinted area E based on the trailing edge of the label 19, but the unprinted area E can be calculated based on the leading edge of the label 19. Furthermore, if the sensor-head distance D1 is less than the character height, printing in the unprinted area E can be determined not possible and the next label 19 can be set to the printing position when the trailing edge of the label 19 is detected.

A detector for detecting the paper width can be disposed in a printer that can print to continuous paper of different widths, and the self-printing data can be generated according to the detected paper width.

The control unit of the printer 1 may be programmed to execute the self-printing process (the steps shown in FIG. 7 and FIG. 8) with the program stored in ROM inside the printer 1. This program can be recorded to a data recording medium, and the program can be read from the data recording into RAM in the printer, and then read and executed from RAM. This program could further alternatively be downloaded from a network. The data recording medium could be flash memory or other type of semiconductor memory device, a floppy disk, hard disk, or other type of magnetic disk, a CD, DVD, magneto-optical, or other type of optical disc, or any other type of data recording medium that can be read electrically, magnetically, optically, or otherwise by a computer.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A printer for printing on continuous paper including label paper having a plurality of labels affixed to a continuous web backing with a gap between the labels, the printer comprising:
a paper transportation control unit configured to control a transportation mechanism to convey the continuous paper along a transportation path;
a printing control unit configured to control a printing mechanism including a print head disposed along the transportation path;
a detector, located on the upstream side of the print head in a transportation direction, configured to detect paper information from the continuous paper; and
a print data generating unit configured to generate self-printing data based on information stored in the printer;
wherein the paper transportation control unit comprises
a printing start position control unit configured to determine a printing start position on the continuous paper for a first line of the self-printing data and configured to position the continuous paper at the printing start position relative to the print head based on the paper information, and
a next-line printing position control unit configured to determine a printing start position on the continuous paper for each consecutive line of the self-printing data to be printed next and configured to position the continuous paper at each consecutive printing start position relative to the print head based on the paper information.

2. The printer of claim 1, wherein
the detector detects an unprintable area on the continuous paper; and
the printing start position control unit positions the continuous paper to start printing from the printable area of the continuous paper adjacent the upstream side of the unprintable area when an unprintable area is detected by the detector before transportation of the continuous paper starts.

3. The printer of claim 2, wherein:
the printing start position control unit starts transporting the continuous paper when an unprintable area is not at the detector before transportation of the continuous paper starts, and positions the continuous paper to start printing from the printable area adjacent the upstream side of the unprintable area when an unprintable area is detected before the continuous paper travels the distance along the transportation path between the detector and the print head after continuous paper transportation starts.

4. The printer of claim 2, wherein:
the printing start position control unit starts transporting the continuous paper when an unprintable area is not at the detector before transportation of the continuous paper starts, and positions the continuous paper to start printing from the printable area positioned at the print head when an unprintable area is detected before the continuous paper travels the distance along the transportation path between the detector and the print head after continuous paper transportation starts.

5. The printer of claim 1, wherein:
the detector detects an unprintable area on the continuous paper;
the next-line printing position control unit comprises
a printable area information acquisition unit configured to acquire information on unprinted area residing in the printable area positioned at the print head, and
a printing process control unit configured to determine if the self-printing data to be printed next can be printed in the unprinted area, and
the next-line printing position control unit positions the continuous paper to start printing from the printable area adjacent on the upstream side of the unprintable area when the printing process control unit determines that the self-printing data to be printed next cannot be printed in the unprinted area.

6. The printer of claim 1, wherein:
the next-line printing position control unit positions the continuous paper every line or every predetermined number of lines.

7. A printing control method for a printer for printing on continuous paper including label paper having a plurality of labels affixed to a continuous web backing with a gap between the labels, the control method comprising steps of:
(a) detecting paper information from the continuous paper by means of a detector located on the upstream side of a print head in a transportation direction;
(b) generating self-printing data based on information stored in the printer;
(c) determining a printing start position on the continuous paper for a first line of the self-printing data and for positioning the continuous paper at the printing start position relative to the print head based on the paper information;
(d) determining a printing start position on the continuous paper for each consecutive line of the self-printing data to be printed next and positioning the continuous paper at each consecutive printing start position relative to the print head based on the paper information after step (c); and
(e) printing the self-printing data on the continuous paper.

8. The printing control method of claim 7, wherein:
step (a) is adapted to detect each printable area and each unprintable area on the continuous paper; and
step (c) positions the continuous paper to start printing from the printable area of the continuous paper adjacent the upstream side of the unprintable area when an unprintable area is detected by the detector before transportation of the continuous paper starts.

9. The printing control method of claim 8, wherein:
step (c) starts transporting the continuous paper when an unprintable area is not at the detector before transportation of the continuous paper starts, and positions the continuous paper to start printing from the printable area adjacent the upstream side of the unprintable area when an unprintable area is detected before the continuous paper travels the distance along the transportation path between the detector and the print head after continuous paper transportation starts.

10. The printing control method of claim 8, wherein:
step (c) starts transporting the continuous paper when an unprintable area is not at the detector before transportation of the continuous paper starts, and positions the continuous paper to start printing from the printable area positioned at the print head when an unprintable area is detected before the continuous paper travels the distance along the transportation path between the detector and the print head after continuous paper transportation starts.

11. The printing control method of claim 7, wherein:
step (a) is adapted to detect each printable area and each unprintable area on the continuous paper; and
step (d) comprises steps of
(d1) acquiring information on unprinted area residing in the printable area positioned at the print head, and
(d2) determining if the self-printing data to be printed next can be printed in the unprinted area, and
step (d) positions the continuous paper to start printing from the printable area adjacent on the upstream side of the unprintable area when step (d2) determines that the self-printing data to be printed next cannot be printed in the unprinted area.

12. The printing control method of claim 7, wherein:
step (d) positions the continuous paper every line or every predetermined number of lines.

13. A computer program for controlling a printer for printing on continuous paper including label paper having a plurality of labels affixed to a continuous web backing with a gap between the labels, wherein the program directs the printer in accordance with a method comprising the steps of:
(a) directing the printer to advance the continuous paper along a given transportation direction aligned relative to the location of a print head;
(b) detecting paper information from the continuous paper to determine where to print on the continuous paper;
(c) causing the printer to generate self-printing data based on information stored in the printer;
(d) determining a printing start position on the continuous paper for a first line of the self-printing data and directing the printer to position the continuous paper to the print head at the position corresponding to the determined printing start position based on the paper information;
(e) determining a printing start position on the continuous paper for each consecutive line of the self-printing data to be printed next and directing the printer to position the continuous paper to the print head at the position corresponding to the determined each consecutive printing start position based on the paper information after step (d); and
(f) directing the printer to print the self-printing data on the continuous paper.
